(19) United States
(12) Patent Application Publication
(10) Pub. No.: US 2011/0286385 A1
(43) Pub. Date: Nov. 24, 2011

(54) Methods and Systems for Communications

(76) Inventors: Cheh Ngee Goh, Singapore (SG); Kaung Paing, London (GB)

(21) Appl. No.: 12/679,433

(22) PCT Filed: Jul. 30, 2008
(86) PCT No.: PCT/SG2008/000279

§ 371 Date: Aug. 3, 2010

Related U.S. Application Data
(60) Provisional application No. 60/994,690, filed on Sep. 21, 2007.

(51) Int. Cl. H04W 4/00

(52) U.S. Cl. 370/328

(57) ABSTRACT

There is provided a method and system for making a call from a first communications device at any location to a recipient with a second communications device by inputting a contact number of the recipient into the first communications device, selecting a communications mode on the first device, wherein at least one of the first communications device and the second communications device operate using at least one data channel, and wherein a caller makes the call in a manner similar to “dial-and-connect” phone calls. There is also provided a method and system for sending at least one message from a first communications device at any location to a recipient with a second communication device by inputting a contact number of the recipient into the first communications device when sending the at least one message, transmitting the contact number and the at least one message to a server through at least one data channel: storing the at least one message at the server; the server contacting the second communications device; and either the second communications device drawing the at least one message from the server through at least one data channel, or the server transmitting the at least one message to the second communications device, wherein the messenger sends the at least one message in a manner similar to “compose-and-send” messaging.

### FIELD OF INVENTION

The present invention relates to methods and systems for communications, particularly in relation to voice communications and text messaging.

### BACKGROUND

Ever since the development of telephones evolved to the stage where callers needed to input a recipient's number to ensure a line connection to the recipient, the process of inputting the recipient's number to ensure a connection to the recipient has not varied much despite numerous improvements to the communications devices of today. This is likely to be so because such a process is rather intuitive.

In this era of globalization, international calls are still an essential form of communication. There are currently several methods which enable users to make international calls. However, a common bugbear for these methods relates to a lack of usability. This problem has hampered the wide-spread take up of the methods.

Some of the aforementioned methods and their inherent problems are discussed in the following paragraphs.

One method for making international calls relates to a use of IDD calling cards. These are pre-paid calling cards which are usable by inputting an associated personal identification number (PIN). The user calls a service number, and enters the PIN number. This enables a duration of talk time, the actual duration being dependent on the call destination. The user may be able to request the service providing system to associate his phone number as the designated calling number. By doing this, there is no necessity to input the PIN subsequently when he makes calls from this designated calling number. Unfortunately, this method does not work if the designated calling number is not identifiable. Furthermore, there is often no way to make use of small value remaining in the card, and hidden costs like connection fees are levied on the user.

Another method for making international calls relates to a use of IDD numbers. This method may be either pre or post paid. Registration with an IDD service provider is typically mandatory. The user usually provides a set of phone numbers from which calls will be made. Thereafter, when the user wants to make a call from the set of phone numbers, a prefix followed by the international telephone number is dialled. Unfortunately, the registration aspect makes it inconvenient for users who are roaming overseas. This method also does not work if the calling number is not identifiable. In addition, the use of the prefix makes contact list management rather confusing as there may be multiple entries for a single contact number. Finally, this method is only usable in a country of the IDD service provider.

There are also call back services where either a caller calls a service provider number and provides a receiver's international number or sends an SMS message containing a receiver's international number to the service provider. The service provider will call the user and then call the receiver to enable communication. Unfortunately, there may be mistakes involved in entering the receiver's number and the cost of roaming SMS is high with no guarantee of the SMS message getting through to the service provider. Furthermore, the SMS message may get delayed.

Another method relates to a “replacement number” method. When a call is made using the aforementioned call back method, a call back server would remember the caller and the destination number, and assign a dedicated local number to this combination. This allows the caller to call the dedicated local number subsequently, where the server will recognise the caller ID and initiate the call back to the destination number used previously. Unfortunately, the recording of the dedicated local number next to the normal full length original number of their destination in a contact list is problematic. Furthermore, there are unfavourable roaming cost issues and service provider sharing issues pertaining to the use of this method.

Based on the aforementioned, it can be seen that the various methods for the making of international calls using existing methods are not ideal and may be improved significantly from a usability aspect.

### SUMMARY

In a first aspect, there is provided a method for making a call from a first communications device at any location to a recipient with a second communications device. The first communications device and the second communications device may be either identical or different The method includes inputting a contact number of the recipient into the first communications device, the contact number being input by selecting from, for example, the contact number from a contact list accessible with the first communications device, by manual input of the contact number, and a pre-determined number. The at least one data channel may include, for example WAP, GPRS, 3G, WiMax, 4G and Wi-Fi.

The method also includes selecting a communications mode on the first device, the communications mode being: “call-back”, “VoIP call” and “prefix call”. Preferably at least one of the first communications device and the second communications device may operate using at least one data channel, and this advantageously allows a caller to make the call in a manner similar to “dial-and-connect” phone calls.

The method may include transmitting the contact number and either the “call-back” or “VoIP call” communications mode to a server via the at least one data channel; and authenticating an identity of the caller at a service provider.

In some embodiments, the method may include selecting the “call-back” communications mode which includes transmitting a preferred calling number; the server instructing a call-back service provider to provide a call-back service; and the caller receiving a call-back at the preferred calling number from the call-back service provider either after the call-back service provider has determined an availability of the recipient or without the call-back service provider determining the availability of the recipient. It is preferable that the call-back mode is a set of instructions transmitted either as data packets or as at least one text message. The call-back service provider may be enabled by a call-back service server. The server instructing the call-back service provider preferably provides the caller's particulars to register the caller with the call-back service provider if the caller is not a registered user of the call-back service provider. A call-back application on the first communications device may be installed to enable the “call-back” mode.

It is advantageous that the contact number being input is stored in the contact list if the contact number is not in the contact list. Preferably, the contact list is accessible either locally or remotely.

It is also advantageous that the registered user of the call-back service provider is able to manage a number of credits recognized by the call-back service provider by performing the steps including sending the call-back service provider details of the registered user and a credit top-up amount; and receiving confirmation of receipt which includes transaction reference details and new credit amount from the call-back service provider. The confirmation of receipt is then sent to the registered user as at least one text message.

In some embodiments, the “VoIP call” communications mode may include the server instructing a VoIP call service provider to provide a VoIP call service; the VoIP call service contacting the second communications device using at least one phone network; the second communications device detecting a contact number of the VoIP call service, and receiving an indication of an incoming VoIP connection without intervention from the recipient; and connecting the first communications device and the second communications device through the VoIP call service via the at least one data channel. It is advantageous that the VoIP call mode utilises the at least one data channel for transmission of voice packets. The VoIP call service provider may be enabled by a VoIP call service server. The server instructing the VoIP call service provider preferably provides the caller's particulars to register the caller with the VoIP call service provider if the caller is not a registered user of the VoIP call service provider. A VoIP call application may be installed on the first communications device to enable the “VoIP call” mode.

Advantageously, the registered user of the VoIP call service provider is able to manage a number of credits recognized by the VoIP call service provider by performing the steps including sending the VoIP call service provider details of the registered user and a credit top-up amount; and receiving confirmation of receipt which includes transaction reference details and new credit amount from the VoIP call service provider. The confirmation of receipt is then sent to the registered user as at least one text message.

When the “prefix call” communications mode is selected, the method includes determining whether the contact number of the recipient is either a local/regional number or an international number. In addition, there is either removal of unnecessary characters or addition of necessary characters to generate a final number, followed by adding a desired prefix to the final number, and using the final number for making a “dial-and-connect” call. It is preferably that the characters are “+”, “*”, “#” and regional prefixes.

The application also discloses a computer readable medium having a computer program code embodied in the medium, wherein the program code is configured to cause a processor in a communications device to execute a series of processes to carry out the aforementioned method.

In a second aspect, there is disclosed a system for making a call from a first communications device at any location to a recipient with a second communications device. The system enables a caller to input a contact number of the recipient into the first communications device, the contact number being input by, for example, the contact number from a contact list accessible with the first communications device, by manual input of the contact number, and a pre-determined number. Selection of a communications mode is then made on the first device, the communications mode being “call-back”, “VoIP call”, and “prefix call”. At least one of the first communications device and the second communications device operate using at least one data channel and it is advantageous that a caller makes the call in a manner similar to “dial-and-connect” phone calls.

The system may further include a server for receiving the contact number and either the “call-back” or “VoIP call” communications modes, and for authenticating an identity of the caller. It is preferable that the at least one data channel is, for example, WAP, GPRS, 3G, WiMax, 4G, and Wi-Fi. The contact number being input may be advantageously stored in the contact list if the contact number is not in the contact list. Preferably, the contact list may be accessible either locally or remotely.

In some embodiments, when selecting the “call-back” communications mode, the server receives a preferred calling number; the server instructs a call-back service provider to provide a call-back service; and the caller receives a call-back at the preferred calling number from the call-back service provider either after the call-back service provider has determined an availability of the recipient or without the call-back service provider determining the availability of the recipient. It is preferable that the call-back request is a set of instructions transmitted either as data packets or as at least one text message. The call-back service provider may be enabled by a call-back service server. Preferably, the server instructing the call-back service provider includes the server providing the caller's particulars to register the caller with the call-back service provider if the caller is not a registered user of the call-back service provider.

The registered user of the call-back service provider may advantageously be able to manage a number of credits recognized by the call-back service provider by performing the steps including: sending the call-back service provider details of the registered user and a credit top-up amount; and receiving confirmation of receipt which includes transaction reference details and new credit amount from the call-back service provider. The confirmation of receipt may be sent to the registered user as at least one text message.

In some embodiments, when selecting the “VoIP call” communications mode, the server instructs a VoIP call service provider to provide a VoIP call service; the VoIP call service contacts the second communications device using at least one phone network; the second communications device detects a contact number of the VoIP call service, and receives an indication of an incoming VoIP connection without intervention from the recipient; and connects the first communications device and the second communications device through the VoIP call service via the at least one data channel. It is advantageous that the VoIP call mode utilises the at least one data channel for transmission of voice packets. The caller may install a VoIP call application on the first communications device to enable the “VoIP call” mode.

It is preferable that the server instructing the VoIP call service provider also provides the caller's particulars to register the caller with the VoIP call service provider if the caller is not a registered user of the VoIP call service provider. The VoIP call service provider may be enabled by a VoIP call service server.

It is preferable that the registered user of the VoIP call service provider is able to manage a number of credits recognized by the VoIP call service provider by performing the steps including sending the VoIP call service provider details of the registered user and a credit top-up amount; and receiving confirmation of receipt which includes transaction reference details and new credit amount from the VoIP call service provider. The confirmation of receipt may be sent to the registered user as at least one text message.

When selecting the “prefix call” communications mode, the first communications device may determine whether the contact number of the recipient is either a local/regional number or an international number. The first communications device may then either remove unnecessary characters or add necessary characters to generate a final number, add a desired prefix to the final number, and then using the final number for making a “dial-and-connect” call. The characters may be selected from the group consisting of: “+”, “*”, “#” and regional prefixes.

In a third aspect, there is provided a method for sending at least one message from a first communications device at any location to a recipient with a second communications device. The first communications device and the second communications device may be either identical or different. The method includes inputting a contact number of the recipient into the first communications device when sending the at least one message, the contact number being input by, for example, the contact number from a contact list accessible with the first communications device, by manual input of the contact number, and a pre-determined number.

The method includes transmitting the contact number and the at least one message to a server through at least one data channel; storing the at least one message at the server; the server contacting the second communications device; and either the second communications device drawing the at least one message from the server through at least one data channel, or the server transmitting the at least one message to the second communications device. It is advantageous that the messager sends the at least one message in a manner similar to “compose-and-send” messaging. It is preferable that the at least one data channel is selected from, for example, WAP, GPRS, 3G, WiMax, 4G, and Wi-Fi. The contact number being input may be stored in the contact list if the contact number is not in the contact list. The contact list may advantageously be accessible either locally or remotely. The method may be enabled by the messager installing a messaging application on the first communications device. Preferably, the at least one message may be, for example, text messages, image-based messages, audio messages, and video messages.

In an embodiment where the server is controlled by a messaging service provider, the first communications device may provide the messager's particulars to register the messager with the messaging service provider if the messager is not a registered user of the messaging service provider.

It is advantageous that the registered user of the texting service provider is able to manage a number of credits recognized by the messaging service provider by performing the steps including: sending the messaging service provider details of the registered user and a credit top-up amount; and receiving confirmation of receipt which includes transaction reference details and new credit amount from the messaging service provider. The confirmation of receipt may be sent to the registered user as at least one message.

In the method, the server preferably contacts the second communications device using existing phone infrastructure, and the second communications device terminates the call from the server once the server's phone number is detected without intervention from the recipient, with the contact from the server indicating a presence of at least one message which needs to be retrieved from the server.

There is also disclosed a computer readable medium having a computer program code embodied in the medium, wherein the program code is configured to cause a processor in a communications device to execute a series of processes to carry out the preceding messaging method.

In a fourth aspect, there is provided a system for sending at least one message from a first communications device at any location to a recipient with a second communications device. The first communications device and the second communications device may be either identical or different. The system enables a messager to input a contact number of the recipient into the first communications device when sending the at least one message, the contact number being input by selecting from, for example, the contact number from a contact list accessible with the first communications device, by manual input of the contact number, and a pre-determined number. The at least one message may be, for example, text messages, image-based messages, audio messages, and video messages.

The contact number and the at least one message may be transmitted to a server through at least one data channel; with the at least one message being stored at the server; the server connecting with the second communications device; and either the second communications device drawing the at least one message from the server through at least one data channel, or the server transmitting the at least one message to the second communications device. It is advantageous that the messager sends the at least one message in a manner similar to “compose-and-send” messaging. The at least one data channel may be selected from the group such as, for example, WAP, GPRS, 3G, WiMax, 4G, and Wi-Fi. The messager may need to install a messaging application on the first communications device.

The contact number being input may be stored in the contact list if the contact number is not in the contact list. The contact list may be accessible either locally or remotely. In an embodiment where the server is controlled by a messaging service provider, the first communications device may provide the messager's particulars to register the messager with the messaging service provider if the messager is not a registered user of the messaging service provider.

Advantageously, the registered user of the texting service provider is able to manage a number of credits recognized by the messaging service provider by performing the steps including: sending the messaging service provider details of the registered user and a credit top-up amount; and receiving confirmation of receipt which includes transaction reference details and new credit amount from the messaging service provider. The confirmation of receipt may be sent to the registered user as at least one message.

In the system, the server preferably contacts the second communications device using existing phone infrastructure, and the second communications device terminates the call from the server once the server's phone number is detected without intervention from the recipient, with the contact from the server indicating a presence of at least one message which needs to be retrieved from the server.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a process flow of a first embodiment.

FIG. 2 shows a process flow of step 30 of FIG. 1.

FIG. 3 shows a process flow of step 31 of FIG. 1.

FIG. 4 shows a process flow of step 32 of FIG. 1.

FIG. 5 shows a process flow of a second embodiment.

FIG. 6 shows a process flow of a credit management aspect of the first and second embodiments.

FIG. 7 shows a system overview of the present invention.

### DESCRIPTION OF PREFERRED EMBODIMENTS

The following embodiments are described in a manner which would be understood by a person skilled in the art to relate to communications on any scale. Any specific limitation which is described in the following sections is solely for illustrative purposes.

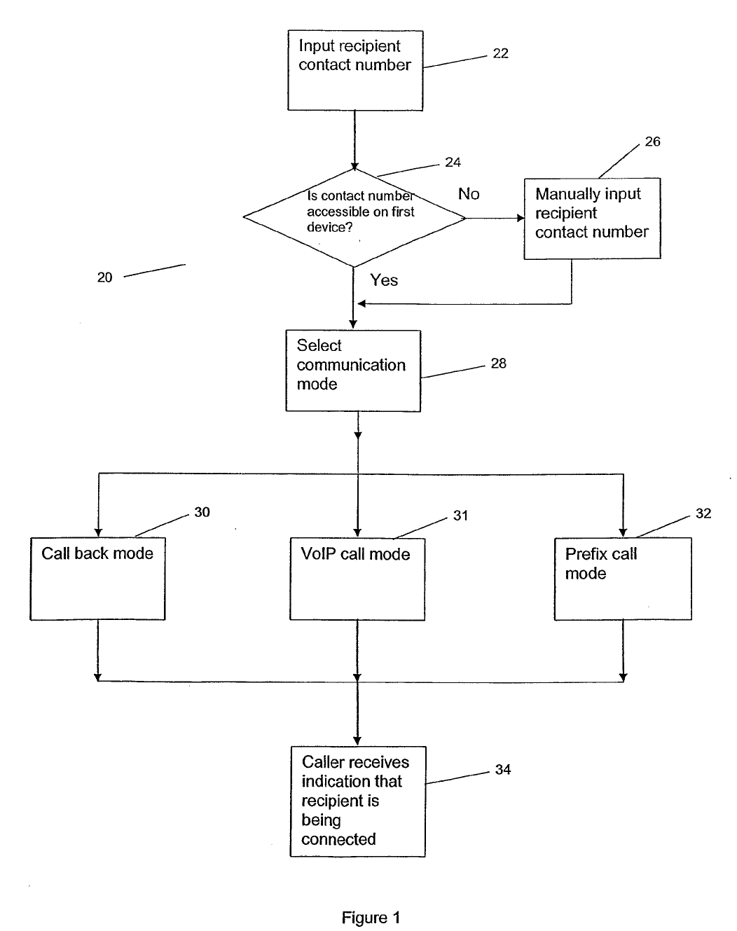

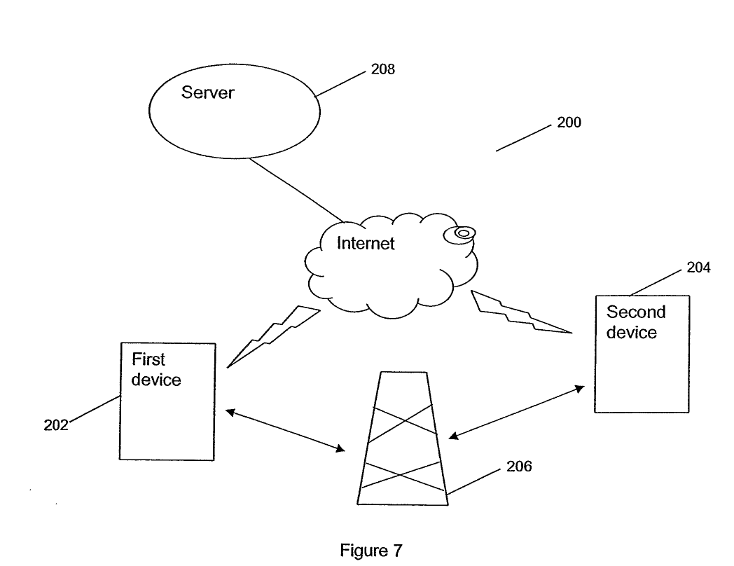

Referring to FIG. 1, there is shown a process flow for a method 20 for making a call from a first communications device 202 at any location to a recipient with a second communications device 204 at another location. FIG. 7 shows a system 200 overview for the method 20. The first and second communications devices 202, 204 may be either mobile telephones or fixed-line telephones. The first communications device 202 and the second communications device 204 may be either identical or different. The first and second communications devices 202, 204 may utilize existing phone infrastructure 206 such as, for example, GSM variants, CDMA, 3G, and so forth. Furthermore, at least one of the first communications device 202 and the second communications device 204 may operate using at least one data channel, such as, for example, WAP, GPRS, 3G, WiMax, Wi-Fi, 4G and so forth. It will be evident from subsequent sections that both the first communications device 202 and the second communications device 204 need not operate using at least one data channel in some instances. Further details of the system 200 will be provided in subsequent sections of the description.

The method 20 for making a call from the first communications device 202 at any location to a recipient with the second communications device 204 at another location includes inputting 22 a contact number of the recipient into the first communications device 202. The contact number may be a pre-determined number like a default number. If the contact number is obtainable 24 from a contact list accessible on the first communications device 202, a caller proceeds with a selection of a communications mode 28 on the first communications device 202, the communications mode being “call-back” 30, “VoIP call” 31 or “prefix call” 32. The contact list may be accessible either locally (stored on the first communications device 202) or remotely (stored on an external storage device and accessed using a data channel). More detailed descriptions of the “call-back” 30 mode, “VoIP call” 31 mode and the “prefix call” 32 mode will be provided in subsequent sections of the description.

If the contact number is not obtainable 24 from a contact list accessible on the first communications device 202, the contact number is manually input 26 into the first communications device 202. The contact number may be a pre-determined number like a default number. The manual input 26 of the recipient contact number may be performed by keying in the contact number using a data input interface such as, for example, a keypad, a keyboard, a voice to text converter, a touch panel and so forth. The contact number being input may be stored in the contact list if the contact number is not in the contact list. The contact number being stored in the contact list may be associated with a recipient identity.

Finally, the caller with the first communications device 202 will receive an indication 34 that the recipient with the second communications device 204 is in a process of being connected. The indication may include, for example, a visual indication, a vibration, an aural tone, any combination of the aforementioned, and the like. It is advantageous that the caller makes the call to the recipient in a manner similar to “dial-and-connect” phone calls.

This manner of usage is intuitive to most communications methods and users will typically welcome the familiarity in usage.

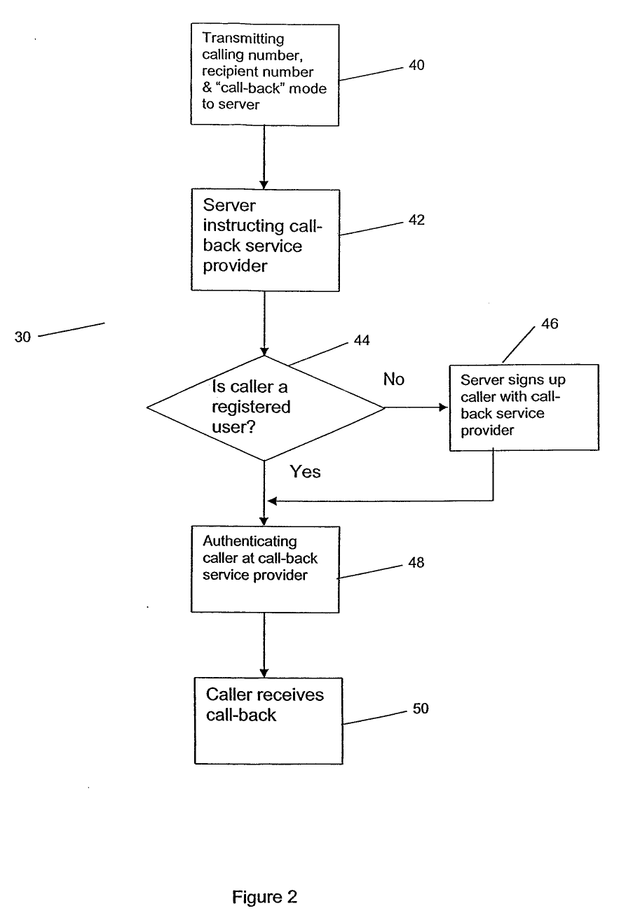

Referring to FIG. 2, there is shown a process flow of the “call-back” mode 30 of FIG. 1. Parts of FIG. 7 are also referenced. Firstly, a preferred calling number, the contact number of the recipient and the “call-back” mode 30 is transmitted 40 from the first communications device 202 to a server 208 via the at least one data channel. Typically, the preferred calling number is a contact number of the first communications device 202. However, the preferred calling number may also be any phone line which the caller may wish to use for the call. The caller is advantageously able to manage call costs if the calling number is selectable. For example, making calls from fixed lines is typically more economical than making calls from mobile lines. It is not mandatory for the preferred calling number to be the contact number of the first communications device 202 even if the preferred calling number, the recipient's contact number and the “call-back” mode 30 is transmitted from the first communications device 202.

The “call-back” mode 30 may be a set of instructions transmitted either as data packets through at least one data channel or as at least one text message. The server 208 may instruct a call-back service provider 42 to provide a call-back service. The server 208 instructing the call-back service provider may determine whether the caller is a registered user of the call-back service 44. The caller's identity need not be associated with the preferred calling number. This allows the caller to use the call-back service from any phone line.

If the caller is not a registered user of the call-back service, the server provides the caller's particulars to register the caller with the call-back service provider 46. If the caller is a registered user of the call back service, the identity of the caller is authenticated at the call-back service provider 48. After the call is authenticated by the call-back service provider, the caller subsequently receives a call-back at the preferred calling number from the call-back service provider 50 prior to the caller receiving the indication of the connection being made to the recipient by the call-back service provider. It is evident that the second communications device 204 need not operate using at least one data channel in the “call-back” mode 30.

Alternatively, the server may check on an availability of the recipient before providing the caller with the indication of the connection being made to the recipient. In such an alternative instance, the server may indicate the availability of the recipient to the caller which may aid in saving cost for the caller as non-availability of the recipient typically would not incur a cost with the call-back service provider.

It should be noted that the call-back service provider may be enabled by a call-back service server. Furthermore, the call-back mode 30 may be enabled by a caller installing a call-back application on the first communications device 202, the call-back application being for managing the call-back mode 30.

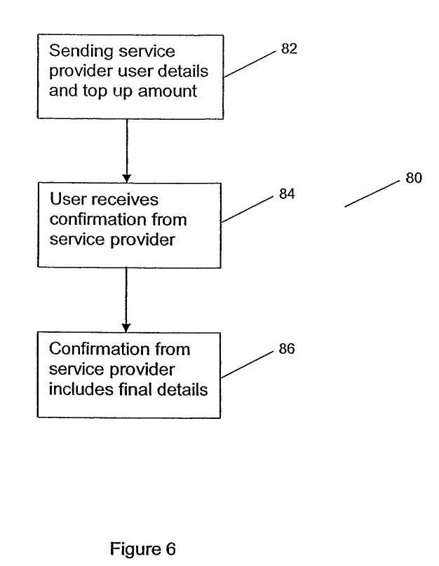

Referring to FIG. 6, there is shown a process flow 80 of a credit management aspect of the first embodiment. The registered user of the call-back service provider may be able to manage a number of credits recognized by the call-back service provider, whereby the credits allow the registered user to pay for usage of the call-back service provided by the call-back service provider. The user may send the call-back service provider registered user details and a credit top-up amount 82. The user may use either at least one data channel or at least one phone network to make the transmission to the call-back service provider. Subsequently, the user may receive confirmation of receipt from the call-back service provider 84. The confirmation of receipt may be sent to the registered user as at least one text message. The confirmation of receipt may include final details like, for example, transaction reference details and new credit amount usable with the call-back service provider 86. This manner of credit management is advantageous for the user as the process may be carried out using the first communications device 202 only at the user's convenience.

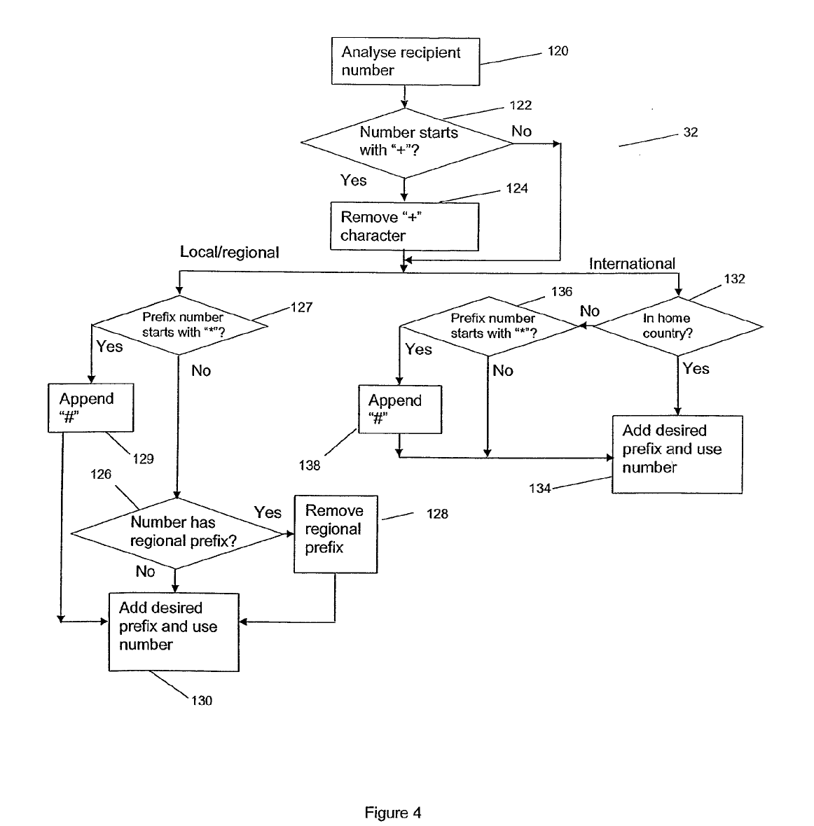

Referring to FIG. 4, there is shown a process flow of the “prefix” mode 32 of FIG. 1. Parts of FIG. 7 are also referenced. Firstly, the contact number of the recipient is analysed 120. One aspect of the analysis is with regard to whether the contact is either a local/regional number or an international number.

The contact number is also analysed to determine whether the number begins with a “+” character 122. If the contact number begins with the “+” character, the “+” character is removed 124.

If the contact number of the recipient is deemed to be local/regional, the number is analysed to determine whether a prefix number begins with a “*” character 127. If the prefix number begins with the “*” character, a “#” character is appended to the end of the contact number 129. At this juncture, the contact number is deemed to be a final number, and a desired prefix is added to the final number 130. If the contact number does not have a prefix number which begins with the “*” character, the number is further analysed to determine whether the number includes a regional prefix 126. If the contact number includes the regional prefix, the regional prefix is removed 128. At this juncture, the contact number is deemed to be a final number, and a desired prefix is added to the final number 132, with the final number and desired prefix being used for making a “dial-and-connect” call.

If the contact number of the recipient is deemed to be an international number, a determination is made regarding a location of the caller 132. However, this determination may not be mandatory. Nevertheless, if the caller is in a home country (a country where the caller's phone service is registered), the contact number is deemed to be a final number, and a desired prefix is added to the final number 134, with the final number and the desired prefix being used for making a “dial-and-connect” call. If the caller is not within the home country, a prefix number is analysed to determine whether the prefix number begins with a “*” character 136. If the prefix number begins with the “*” character, a “#” character is appended to the end of the contact number 138. At this juncture, the contact number is deemed to be a final number, and a desired prefix is added to the final number 134, with the final number and the desired prefix being used for making a “dial-and-connect” call. It is also evident that the second communications device 204 need not operate using at least one data channel in the “prefix” mode 32.

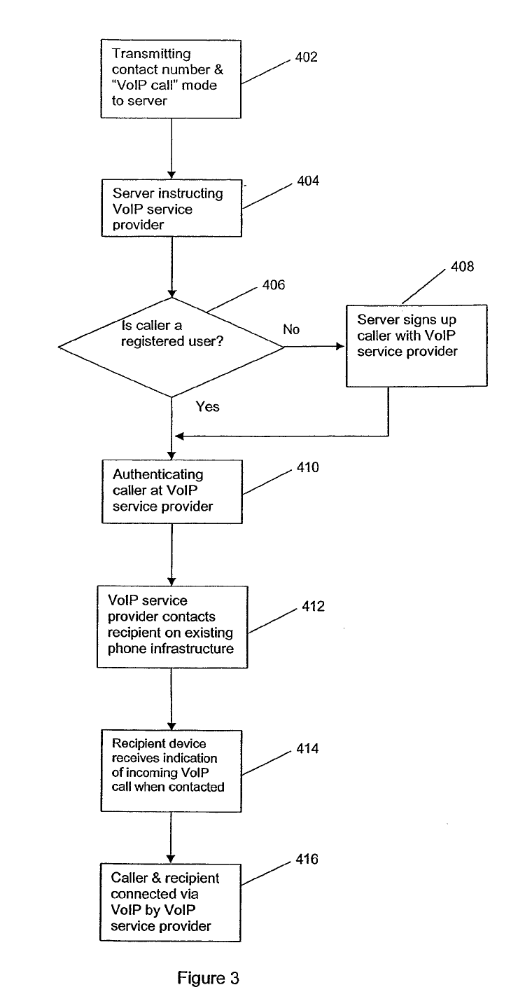

Referring to FIG. 3, there is shown a process flow of the “VoIP call” mode 31 of FIG. 1. Parts of FIG. 7 are also referenced. Firstly, the contact number of the recipient and the “VoIP call” mode 31 is transmitted 402 from the first communications device 202 to a server 208 via the at least one data channel. The “VoIP call” mode 31 may be a set of instructions transmitted either as data packets through at least one data channel or as at least one text message. The “VoIP call” mode 31 may utilise the at least one data channel for transmission of voice packets. The server 208 may instruct a VoIP call service provider 404 to provide a VoIP call service. The server 208 instructing the VoIP call service provider may determine whether the caller is a registered user of the VoIP call service 406.

If the caller is not a registered user of the VoIP call service, the server provides the caller's particulars to register the caller with the VoIP call service provider 408. If the caller is a registered user of the VoIP call service, the identity of the caller is authenticated at the VoIP call service provider 410.

The server 208 then contacts 412 the second communications device 204. The server 208 makes a call to the second communications device 204 using existing phone infrastructure. Detection of the server's 208 phone number may be done by the second communications device 204 using known caller ID detection processes without any intervention from the recipient.

Subsequently, though not necessarily in this order, the second communications device 204 terminates the call from the server 208 once the server's 208 phone number is detected. As such, when the server's 208 phone number is detected, there is an indication to the second communications device 204 of a presence of an incoming VoIP connection which needs the device 204 to connect to the server 208 via the at least one data channel to complete 414. Upon connection to the server 208, the server 208 then proceeds with any known VoIP call mechanism to connect 416 the first communications device 202 with the second communications device 204. The first communications device 202 may remain continually connected to the server 208 during the mode 31. The process of the server 208 contacting 412 the second communications device 204 and connecting 416 the second communications device 204 to the first communications device 202 may be nearly instantaneous. It is evident that the second communications device 204 operates using at least one data channel in the “VoIP call” mode 31.

It should be noted that the VoIP call service provider may be enabled by a VoIP call service server. Furthermore, the “VoIP call” mode 31 may be enabled by a caller installing a VoIP call application on the first communications device 202, the VoIP call application being for managing the VoIP call mode 30.

Referring to FIG. 6, there is shown a process flow 80 of a credit management aspect of the first embodiment. The registered user of the VoIP call service provider may be able to manage a number of credits recognized by the VoIP call service provider, whereby the credits allow the registered user to pay for usage of the VoIP call service provided by the VoIP call service provider. The user may send the VoIP call service provider registered user details and a credit top-up amount 82. The user may use either at least one data channel or at least one phone network to make the transmission to the VoIP call service provider. Subsequently, the user may receive confirmation of receipt from the VoIP call service provider 84. The confirmation of receipt may be sent to the registered user as at least one text message. The confirmation of receipt may include final details like, for example, transaction reference details and new credit amount usable with the VoIP call service provider 86. This manner of credit management is advantageous for the user as the process may be carried out using the first communications device 202 only at the user's convenience.

It should be noted that the aforementioned embodiments may be applied onto a computer readable medium having a computer program code embodied in the medium, wherein the program code is configured to cause a processor in the communications device 202, 204 to execute a series of processes to carry out the aforementioned embodiments.

In another aspect, with reference to FIG. 7, there is provided a system 200 for making a call from a first communications device 202 at any location to a recipient with a second communications device 204 at another location. The first and second communications devices 202, 204 may be either mobile telephones or fixed-line telephones. The first communications device 202 and the second communications device 204 may be either identical or different. The first and second communications devices 202, 204 may utilize existing phone infrastructure 206 such as, for example, GSM variants, CDMA, 3G, and so forth. Furthermore, at least one of the first communications device 202 and the second communications device 204 may operate using at least one data channel, such as, for example, WAP, GPRS, 3G, WiMax, Wi-Fi, 4G and so forth. It will be evident from subsequent sections that both the first communications device 202 and the second communications device 204 need not operate using at least one data channel in some instances.

The system 200 enables the making of a call from the first communications device 202 at any location to a recipient with the second communications device 204 at another location as per FIG. 1 as described earlier. The system 100 allows inputting 22 a contact number of the recipient into the first communications device 202. The contact number may be a pre-determined number like a default number. If the contact number is obtainable 24 from a contact list accessible on the first communications device 202, a caller proceeds with a selection of a communications mode 28 on the first communications device 202, the communications mode being “call-back” 30, “VoIP” 31 or “prefix call” 32. The contact list may be accessible either locally (stored on the first communications device 202) or remotely (stored on an external storage device and accessed using a data channel). More detailed descriptions of the “call-back” 30 mode, “VoIP” 31 mode, and the “prefix call” 32 mode will be provided in subsequent sections of the description.

If the contact number is not obtainable 24 from a contact list accessible on the first communications device 202, the contact number is manually input 26 into the first communications device 202. The contact number may be a pre-determined number like a default number. The manual input 26 of the recipient contact number may be performed by keying in the contact number using a data input interface such as, for example, a keypad, a keyboard, a voice to text converter, a touch panel and so forth. The contact number being input may be stored in the contact list if the contact number is not in the contact list. The contact number being stored in the contact list may be associated with a recipient identity.

Finally, the caller with the first communications device 202 will receive an indication that the recipient with the second communications device 204 is in the process of being connected. The indication may include, for example, a visual indication, a vibration, an aural tone, any combination of the aforementioned, and the like. It is advantageous that the caller makes the call to the recipient in a manner similar to “dial-and-connect” phone calls. This manner of usage enabled by the system 200 is intuitive to most communications methods and users will typically welcome the familiarity in usage.

The system 200 also enables the process referred to in FIG. 2, namely, the “call-back” mode 30 of FIG. 1. Firstly, the preferred calling number, the contact number of the recipient and the “call-back” mode 30 is transmitted 40 from the first communications device 202 to a server 208 via the at least one data channel. Typically, the preferred calling number is a contact number of the first communications device 202. However, the preferred calling number may also be any phone line which the caller may wish to use for the call. The caller is advantageously able to manage call costs if the calling number is selectable. For example, making calls from fixed lines is typically more economical than making calls from mobile lines. It is not mandatory for the preferred calling number to be the contact number of the first communications device 202 even if the preferred calling number, the recipient's contact number and the “call-back” mode 30 is transmitted from the first communications device 202.

The call-back mode may be a set of instructions transmitted either as data packets through at least one data channel or as at least one text message. The server 208 may instruct a call-back service provider 42 to provide a call-back service. The server 208 instructing the call-back service provider may determine whether the caller is a registered user of the call-back service. The caller's identity need not be associated with the calling number. This allows the caller to use the call-back service from any phone line.

If the caller is not a registered user of the call-back service, the server providing the caller's particulars to register the caller with the call-back service provider 46. If the caller is a registered user of the call back service, the identity of the caller is authenticated at the call-back service provider 48. After the call is authenticated by the call-back service provider, the caller subsequently receives a call-back at the preferred calling number from the call-back service provider 50 prior to the caller receiving an indication of the connection being made to the recipient by the call-back service provider. It is evident that the second communications device 204 need not operate using at least one data channel in the “call-back” mode 30.

Alternatively, the server may check on an availability of the recipient before providing the caller with the indication of the connection being made to the recipient. In such an alternative instance, the server may indicate the availability of the recipient to the caller which may aid in saving cost for the caller as non-availability of the recipient typically would not incur a cost with the call-back service provider.

It should be noted that the call-back service provider may be enabled by a call-back service server. Furthermore, the “call-back” mode 30 may be enabled by a caller installing a call-back application on the first communications device 202, the call-back application being for managing the “call-back” mode 30.

The system 200 may also enable a process flow 80 of a credit management aspect of the first embodiment. The registered user of the call-back service provider may be able to manage a number of credits recognized by the call-back service provider, whereby the credits allow the registered user to pay for usage of the call-back service provided by the call-back service provider. The user may send the call-back service provider registered user details and a credit top-up amount 82. The user may use at least one data channel or at least one phone network to make the transmission to the call-back service provider. Subsequently, the user may receive confirmation of receipt from the call-back service provider 84. The confirmation of receipt may be sent to the registered user as at least one text message. The confirmation of receipt may include final details like, for example, transaction reference details and new credit amount usable with the call-back service provider 86. This manner of credit management is advantageous for the user as the process may be carried out using the first communications device 202 only.

The system 200 is able to enable the process referred to in FIG. 3, namely, the “VoIP call” mode 31 of FIG. 1. Firstly, the contact number of the recipient and the “VoIP call” mode 31 is transmitted 402 from the first communications device 202 to a server 208 via the at least one data channel. The “VoIP call” mode 31 may be a set of instructions transmitted either as data packets through at least one data channel or as at least one text message. The “VoIP call” mode 31 may utilise the at least one data channel for transmission of voice packets. The server 208 may instruct a VoIP call service provider 404 to provide a VoIP call service. The server 208 instructing the VoIP call service provider may determine whether the caller is a registered user of the VoIP call service 406.

If the caller is not a registered user of the VoIP call service, the server provides the caller's particulars to register the caller with the VoIP call service provider 408. If the caller is a registered user of the VoIP call service, the identity of the caller is authenticated at the VoIP call service provider 410.

The server 208 then contacts 412 the second communications device 204. The server 208 makes a call to the second communications device 204 using existing phone infrastructure. Detection of the server's 208 phone number may be done by the second communications device 204 using known caller ID detection processes without any intervention from the recipient.

Subsequently, though not necessarily in this order, the second communications device 204 terminates the call from the server 208 once the server's 208 phone number is detected. As such, when the server's 208 phone number is detected, there is an indication to the second communications device 204 of a presence of an incoming VoIP connection which needs the device 204 to connect to the server 208 via the at least one data channel to complete 414. Upon connection to the server 208, the server 208 then proceeds with any known VoIP call mechanism to connect 416 the first communications device 202 with the second communications device 204. The first communications device 202 may remain continually connected to the server 208 during the mode 31. The process of the server 208 contacting 412 the second communications device 204 and connecting 416 the second communications device 204 to the first communications device 202 may be nearly instantaneous. It is evident that the second communications device 204 operates using at least one data channel in the “VoIP call” mode 31.

It should be noted that the VoIP call service provider may be enabled by a VoIP call service server. Furthermore, the “VoIP call” mode 31 may be enabled by a caller installing a VoIP call application on the first communications device 202, the VoIP call application being for managing the “VoIP call” mode 31.

Furthermore, if the VoIP call service server is unable to interface with a VoIP call application on the second communications device 204, the VoIP service provider may inform the caller as such.

The system is able to enable the process flow 80 of a credit management aspect of the first embodiment. The registered user of the VoIP call service provider may be able to manage a number of credits recognized by the VoIP call service provider, whereby the credits allow the registered user to pay for usage of the VoIP call service provided by the VoIP call service provider. The user may send the VoIP call service provider registered user details and a credit top-up amount 82. The user may use either at least one data channel or at least one phone network to make the transmission to the VoIP call service provider. Subsequently, the user may receive confirmation of receipt from the VoIP call service provider 84. The confirmation of receipt may be sent to the registered user as at least one text message. The confirmation of receipt may include final details like, for example, transaction reference details and new credit amount usable with the VoIP call service provider 86. This manner of credit management is advantageous for the user as the process may be carried out using the first communications device 202 only at the users convenience.

The system 200 also enables the process 32 referred to in FIG. 4, namely, the “prefix” mode 30 of FIG. 1. The components of the system 200 work together the enable the process 32 referred to in FIG. 4 when carrying out a set of instructions. The set of instructions may be controlled centrally or by each individual component.

Firstly, the contact number of the recipient is analysed 120. One aspect of the analysis is with regard to whether the contact is either a local/regional number or an international number.

The contact number is also analysed to determine whether the number begins with a “+” character 122. If the contact number begins with the “+” character, the “+” character is removed 124.

If the contact number of the recipient is deemed to be local/regional, the number is analysed to determine whether a prefix number begins with a “*” character 127. If the prefix number begins with the “*” character, a “#” character is appended to the end of the contact number 129. At this juncture, the contact number is deemed to be a final number, and a desired prefix is added to the final number 130. If the contact number does not have a prefix number which begins with the “*” character, the number is further analysed to determine whether the number includes a regional prefix 126. If the contact number includes the regional prefix, the regional prefix is removed 128. At this juncture, the contact number is deemed to be a final number, and a desired prefix is added to the final number 132, with the final number and desired prefix being used for making a “dial-and-connect” call.

If the contact number of the recipient is deemed to be an international number, a determination is made regarding a location of the caller 132. However, this determination may not be mandatory. Nevertheless, if the caller is in a home country (a country where the caller's phone service is registered), the contact number is deemed to be a final number, and a desired prefix is added to the final number 134, with the final number and the desired prefix being used for making a “dial-and-connect” call. If the caller is not within the home country, a prefix number is analysed to determine whether the prefix number begins with a “*” character 136. If the prefix number begins with the “*” character, a “#” character is appended to the end of the contact number 138. At this juncture, the contact number is deemed to be a final number, and a desired prefix is added to the final number 134, with the final number and the desired prefix being used for making a “dial-and-connect” call. It is again evident that the second communications device 204 need not operate using at least one data channel in the “prefix” mode 32.

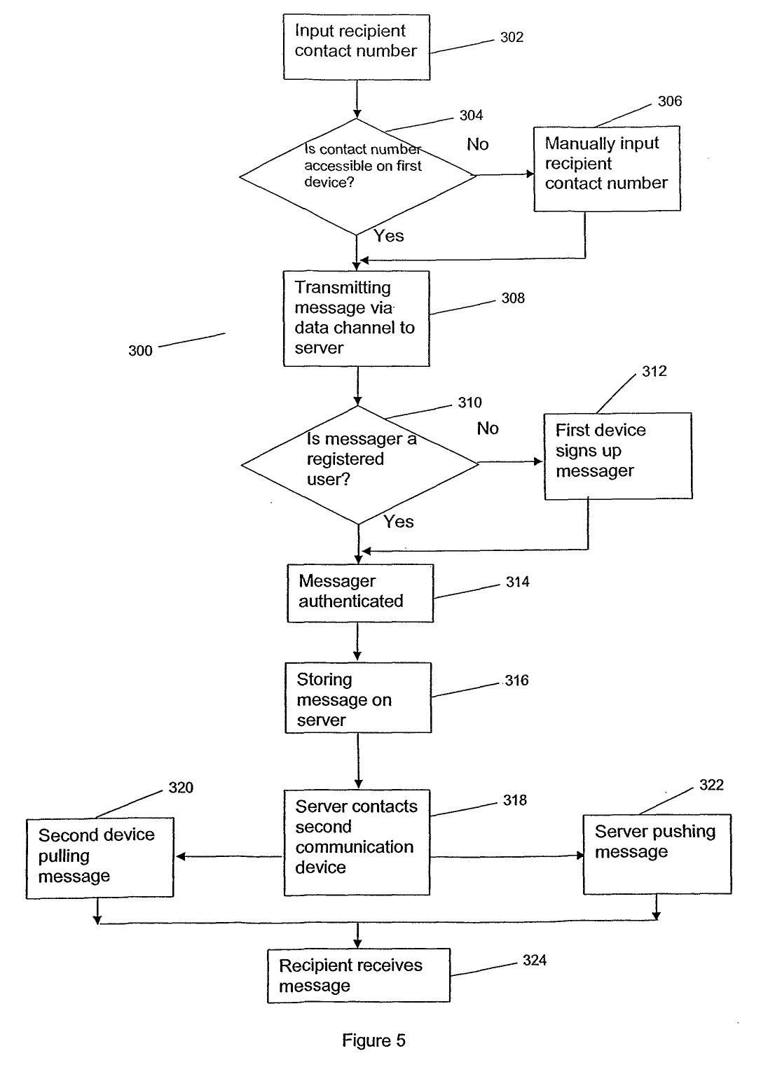

Referring to FIG. 5, there is shown a process flow of a second embodiment. There is shown a method 300 for sending at least one message from a first communications device 202 at any location to a recipient with a second communications device 204 at another location. The at least one message may be, for example, text messages, image-based messages, audio messages, video messages, and so forth. It should be noted that the at least one message may be of any data size as long as the first communications device 202 is able to compose the at least one message and the second communications device 204 is able to support the at least one message.

FIG. 7 shows a system 200 overview for the method 300. The first and second communications devices 202, 204 may be either mobile telephones or fixed-line telephones. The first communications device 202 and the second communications device 204 may be either identical or different. The first and second communications devices 202, 204 may utilize existing phone infrastructure 206 such as, for example, GSM variants, CDMA, 3G, and so forth. Furthermore, both the first communications device 202 and the second communications device 204 may operate using at least one data channel, such as, for example, WAP, GPRS, 3G, WiMax, Wi-Fi, 4G and so forth.

The method 300 includes inputting 302 a contact number of the recipient into the first communications device 202. The contact number may be a pre-determined number like a default number. If the contact number is obtainable 304 from a contact list accessible on the first communications device 202, a messager proceeds with transmitting at least one composed message 308 via at least one data channel to a server 208. The contact list may be accessible either locally (stored on the first communications device 202) or remotely (stored on an external storage device and accessed using a data channel).

If the contact number is not obtainable 304 from a contact list accessible on the first communications device 202, the contact number is manually input 306 into the first communications device 202. The contact number may be a pre-determined number like a default number. The manual input 306 of the recipient contact number may be performed by keying in the contact number using a data input interface such as, for example, a keypad, a keyboard, a voice to text converter, a touch panel and so forth. The contact number being input may be stored in the contact list if the contact number is not in the contact list. The contact number being stored in the contact list may be associated with a recipient identity.

The server 208 may determine whether the messager is a registered user of a messaging service 310. If the messager is not a registered user of the messaging service, the first communications device 202 provides the messager's particulars to register the messager with the messaging service provider 312. If the messager is a registered user of the messaging service, the identity of the messager may be authenticated 314 at the server 208.

Subsequently, the at least one composed message may be stored at the server 316. The server 208 then contacts 318 the second communications device 204. The server 208 makes a call to the second communications device 204 using existing phone infrastructure. Detection of the server's 208 phone number may be done by the second communications device 204 using known caller ID detection processes without any intervention from the recipient. Subsequently, the second communications device 204 may terminate the call from the server 208 once the server's 208 phone number is detected. As such, when the server's 208 phone number is detected, there is an indication to the second communications device 204 of a presence of at least one message which needs to be retrieved from the server 208.

At this juncture, either the second communications device 204 draws 320 the at least one message from the server 208 through at least one data channel 324, or the server transmits 322 the at least one message to the second communications device 204 (324). This option of how the at least one message is delivered to the second communications device 204 may be dependent on, for example, the messager's preference, the messager's registration level with the server 208, the recipient's registration level with the server 208, settings on the second communications device 204 and so forth. It is advantageous that the method 300 allows the messager to send the at least one message in a manner similar to “compose-and-send” texting, while not accumulating costs while messaging using existing phone networks. It should be noted that the server 208 may enable a messaging service and may be operated by a messaging service provider.

It should be appreciated that the method 300 may be enabled by the installation of a messaging application on the first communications device 202.

It is preferable that the messaging application mimics the usability of typical messaging applications found on communications devices, especially in the manner of “compose-and-send” type of texting.

Referring to FIG. 6, there is shown a process flow 80 of a credit management aspect of the second embodiment. The registered user of the messaging service provider may be able to manage a number of credits recognized by the messaging service provider, whereby the credits allow the registered user to pay for usage of the messaging service provided by the messaging service provider. The user may send the messaging service provider registered user details and a credit top-up amount 82. The user may use either at least one data channel or at least one phone network to make the transmission to the messaging service provider. Subsequently, the user may receive confirmation of receipt from the messaging service provider 84. The confirmation of receipt may be sent to the registered user as at least one message. The confirmation of receipt may include final details like, for example, transaction reference details and new credit amount usable with the messaging service provider 86. This manner of credit management is advantageous for the user as the process may be carried out using the first communications device 202 only at the user's convenience.

It should be noted that the aforementioned embodiment relating to messaging may be applied onto a computer readable medium having a computer program code embodied in the medium, wherein the program code is configured to cause a processor in the communications device 202, 204 to execute a series of processes to carry out the aforementioned embodiment relating to messaging.

In a final aspect, with reference to FIG. 7, there is provided a system 200 for enabling the sending of at least one message from a first communications device 202 at any location to a recipient with a second communications device 204 at another location. The at least one message may be, for example, text messages, image-based messages, audio messages, video messages, and so forth. It should be noted that the at least one message may be of any data size as long as the first communications device 202 is able to compose the at least one message and the second communications device 204 is able to support the at least one message.

FIG. 7 shows a system 200 overview for the method 300. The first and second communications devices 202, 204 may be either mobile telephones or fixed-line telephones. The first communications device 202 and the second communications device 204 may be either identical or different. The first and second communications devices 202, 204 may utilize existing phone infrastructure 206 such as, for example, GSM variants, CDMA, 3G, and so forth. Furthermore, both the first communications device 202 and the second communications device 204 may operate using at least one data channel, such as, for example, WAP, GPRS, 3G, WiMax, Wi-Fi, 4G and so forth.

The system 200 enables the sending of at least one message from a first communications device 202 at any location to a recipient with a second communications device 204 at another location as per FIG. 5 as described earlier. The method 300 includes inputting 302 a contact number of the recipient into the first communications device 202. The contact number may be a pre-determined number like a default number. If the contact number is obtainable 304 from a contact list accessible on the first communications device 202, a messager proceeds with transmitting at least one composed message 308 via at least one data channel to a server 208. The contact list may be accessible either locally (stored on the first communications device 202) or remotely (stored on an external storage device and accessed using a data channel).

If the contact number is not obtainable 304 from a contact list accessible on the first communications device 202, the contact number is manually input 306 into the first communications device 202. The contact number may be a pre-determined number like a default number. The manual input 306 of the recipient contact number may be performed by keying in the contact number using a data input interface such as, for example, a keypad, a keyboard, a voice to text converter, a touch panel and so forth. The contact number being input may be stored in the contact list if the contact number is not in the contact list. The contact number being stored in the contact list may be associated with a recipient identity.

The server 208 may determine whether the messager is a registered user of a messaging service 310. If the messager is not a registered user of the messaging service, the first communications device 202 provides the messager's particulars to register the messager with the messaging service provider 312. If the messager is a registered user of the messaging service, the identity of the messager may be authenticated 314 at the server 208.

Subsequently, the at least one composed message may be stored at the server 316. The server 208 then contacts 318 the second communications device 204. The server 208 makes a call to the second communications device 204 using existing phone infrastructure. Detection of the server's 208 phone number may be done by the second communications device 204 using known caller ID detection processes without any intervention from the recipient. Subsequently, the second communications device 204 may terminate the call from the server 208 once the server's 208 phone number is detected. As such, when the server's 208 phone number is detected, there is an indication to the second communications device 204 of a presence of at least one message which needs to be retrieved from the server 208.

At this juncture, either the second communications device 204 draws 320 the at least one message from the server 208 through at least one data channel 324, or the server transmits 322 the at least one message to the second communications device 204 (324). This option of how the at least one message is delivered to the second communications device 204 may be dependent on, for example, the messager's preference, the messager's registration level with the server 208, the recipient's registration level with the server 208, settings on the second communications device 204 and so forth. It is advantageous that the method 300 allows the messager to send the at least one message in a manner similar to “compose-and-send” messaging, while not accumulating costs while messaging using existing phone networks. It should be noted that the server 208 may enable a messaging service and may be operated by a messaging service provider.

It should be appreciated that the method 300 enabled by the system 200 may be further enabled by the installation of a messaging application on the first communications device 202. It is preferable that the messaging application mimics the usability of typical messaging applications found on communications devices, especially in the manner of “compose-and-send” type of messaging.

The system 200 may also enable a process flow 80 of a credit management aspect of the second embodiment. The registered user of the messaging service provider may be able to manage a number of credits recognized by the messaging service provider, whereby the credits allow the registered user to pay for usage of the messaging service provided by the messaging service provider. The user may send the messaging service provider registered user details and a credit top-up amount 82. The user may use either at least one data channel or at least one phone network to make the transmission to the messaging service provider. Subsequently, the user may receive confirmation of receipt from the messaging service provider 84. The confirmation of receipt may be sent to the registered user as at least one message. The confirmation of receipt may include final details like, for example, transaction reference details and new credit amount usable with the messaging service provider 86. This manner of credit management is advantageous for the user as the process may be carried out using the first communications device 202 only at the user's convenience.

Whilst there has been described in the foregoing description preferred embodiments of the present invention, it will be understood by those skilled in the technology concerned that many variations or modifications in details of design or construction may be made without departing from the present invention.

1. A method for making a call from a first communications device at any location to a recipient with a second communications device, the method including:
inputting a contact number of the recipient into the first communications device, the contact number being input by selecting from a group comprising: the contact number from a contact list accessible with the first communications device, by manual input of the contact number, and a pre-determined number; and
selecting a communications mode on the first device, the communications mode being selected from a group comprising: “call-back”, “VoIP call” and “prefix call”;
wherein at least one of the first communications device and the second communications device operate using at least one data channel, and wherein a caller makes the call in a manner similar to “dial-and-connect” phone calls.

2. The method of claim 1, wherein both the first communications device and the second communications device are either identical or different.

3. The method of claim 1, further including:
transmitting the contact number and either the “call-back” or “VoIP call” communications mode to a server via the at least one data channel; and
authenticating an identity of the caller at a service provider.

4. The method of claim 1, wherein the at least one data channel is selected from the group comprising: WAP, GPRS, 3G, WiMax, 4G and Wi-Fi.

5. The method of claim 1, wherein the contact number being input is stored in the contact list if the contact number is not in the contact list.

6. The method of claim 1, wherein the contact list is accessible either locally or remotely.

7. The method of claim 3, wherein selecting the “call-back” communications mode includes:
transmitting a preferred calling number;
the server instructing a call-back service provider to provide a call-back service; and
the caller receiving a call-back at the preferred calling number from the call-back service provider either after the call-back service provider has determined an availability of the recipient or without the call-back service provider determining the availability of the recipient,
wherein the call-back mode is a set of instructions transmitted either as data packets or as at least one text message.

8. The method of claim 7, wherein the server instructing the call-back service provider provides the caller's particulars to register the caller with the call-back service provider if the caller is not a registered user of the call-back service provider.

9. The method of claim 7, wherein the call-back service provider is enabled by a call-back service server.

10. The method of claim 9, wherein the registered user of the call-back service provider is able to manage a number of credits recognized by the call-back service provider by performing the steps including:
sending the call-back service provider details of the registered user and a credit top-up amount; and
receiving confirmation of receipt which includes transaction reference details and new credit amount from the call-back service provider;
wherein the confirmation of receipt is sent to the registered user as at least one text message.

11. The method of claim 8, further including the caller installing a call-back application on the first communications device.

12. The method of claim 3, wherein selecting the “VoIP call” communications mode includes:
the server instructing a VoIP call service provider to provide a VoIP call service;
the VoIP call service contacting the second communications device using at least one phone network;
the second communications device detecting a contact number of the VoIP call service, and receiving an indication of an incoming VoIP connection without intervention from the recipient; and
connecting the first communications device and the second communications device through the VoIP call service via the at least one data channel;
wherein the VoIP call mode utilises the at least one data channel for transmission of voice packets.

13. The method of claim 12, wherein the server instructing the VoIP call service provider provides the caller's particulars to register the caller with the VoIP call service provider if the caller is not a registered user of the VoIP call service provider.

14. The method of claim 12, wherein the VoIP call service provider is enabled by a VoIP call service server.

15. The method of claim 14, wherein the registered user of the VoIP call service provider is able to manage a number of credits recognized by the VoIP call service provider by performing the steps including:
sending the VoIP call service provider details of the registered user and a credit top-up amount; and
receiving confirmation of receipt which includes transaction reference details and new credit amount from the VoIP call service provider;
wherein the confirmation of receipt is sent to the registered user as at least one text message.

16. The method of claim 13, further including the caller installing a VoIP call application on the first communications device.

17. The method of claim 1, wherein selecting the “prefix call” communications mode includes:
determining whether the contact number of the recipient is either a local/regional number or an international number;
analyzing either the local/regional number or the international number to either remove unnecessary characters or add necessary characters to generate a final number;
adding a desired prefix to the final number, and
using the final number for making a “dial-and-connect” call.

18. The method of claim 17, wherein the characters are selected from the group consisting of: “+”, “*”, “#” and regional prefixes.

19. A computer readable medium having a computer program code embodied in the medium, wherein the program code is configured to cause a processor in a communications device to execute a series of processes to carry out the method of claim 1.

20. A system for making a call from a first communications device at any location to a recipient with a second communications device, the system enabling a caller to:
input a contact number of the recipient into the first communications device, the contact number being input by selecting from a group comprising: the contact number from a contact list accessible with the first communications device, by manual input of the contact number, and a pre-determined number; and
select a communications mode on the first device, the communications mode being selected from a group comprising: “call-back”, “VoIP call”, and “prefix call”;
wherein at least one of the first communications device and the second communications device operate using at least one data channel and wherein a caller makes the call in a manner similar to “dial-and-connect” phone calls.

21. The system of claim 20, wherein both the first communications device and the second communications device are either identical or different.

22. The system of claim 20, further including a server for receiving the contact number and either the “call-back” or “VoIP call” communications modes, and for authenticating an identity of the caller.

23. The system of claim 20, wherein the at least one data channel is selected from the group comprising: WAP, GPRS, 3G, WiMax, 4G, and Wi-Fi.

24. The system of claim 20, wherein the contact number being input is stored in the contact list if the contact number is not in the contact list.

25. The system of claim 20, wherein the contact list is accessible either locally or remotely.

26. The system of claim 20, wherein selecting the “call-back” communications mode includes:
the server receiving a preferred calling number;
the server instructing a call-back service provider to provide a call-back service; and
the caller receiving a call-back at the preferred calling number from the call-back service provider either after the call-back service provider has determined an availability of the recipient or without the call-back service provider determining the availability of the recipient,
wherein the call-back request is a set of instructions transmitted either as data packets or as at least one text message.

27. The system of claim 26, wherein the call-back service provider is enabled by a call-back service server.

28. The system of claim 26, wherein the server instructing the call-back service provider provides the caller's particulars to register the caller with the call-back service provider if the caller is not a registered user of the call-back service provider.

29. The system of claim 28, wherein the registered user of the call-back service provider is able to manage a number of credits recognized by the call-back service provider by performing the steps including:
sending the call-back service provider details of the registered user and a credit top-up amount; and
receiving confirmation of receipt which includes transaction reference details and new credit amount from the call-back service provider;
wherein the confirmation of receipt is sent to the registered user as at least one text message.

30. The system of claim 22, wherein selecting the “VoIP call” communications mode includes:
the server instructing a VoIP call service provider to provide a VoIP call service;
the VoIP call service contacting the second communications device using at least one phone network;
the second communications device detecting a contact number of the VoIP call service, and receiving an indication of an incoming VoIP connection without intervention from the recipient; and
connecting the first communications device and the second communications device through the VoIP call service via the at least one data channel;
wherein the VoIP call mode utilises the at least one data channel for transmission of voice packets.

31. The system of claim 30, wherein the server instructing the VoIP call service provider provides the caller's particulars to register the caller with the VoIP call service provider if the caller is not a registered user of the VoIP call service provider.

32. The system of claim 30, wherein the VoIP call service provider is enabled by a VoIP call service server.

33. The system of claim 32, wherein the registered user of the VoIP call service provider is able to manage a number of credits recognized by the VoIP call service provider by performing the steps including:
sending the VoIP call service provider details of the registered user and a credit top-up amount; and
receiving confirmation of receipt which includes transaction reference details and new credit amount from the VoIP call service provider;
wherein the confirmation of receipt is sent to the registered user as at least one text message.

34. The system of claim 30, further including the caller installing a VoIP call application on the first communications device.

35. The system of claim 20, wherein selecting the “prefix call” communications mode includes:
the first communications device determining whether the contact number of the recipient is either a local/regional number or an international number;
the first communications device analyzing either the local/regional number or the international number to either remove unnecessary characters or add necessary characters to generate a final number;
the first communications device adding a desired prefix to the final number, and
the first communications device using the final number for making a “dial-and-connect” call.

36. The system of claim 35, wherein the characters are selected from the group consisting of: “+”, “*”, “#” and regional prefixes.

37. A method for sending at least one message from a first communications device at any location to a recipient with a second communications device, the method including:
inputting a contact number of the recipient into the first communications device when sending the at least one message, the contact number being input by selecting from a group comprising: the contact number from a contact list accessible with the first communications device, by manual input of the contact number, and a pre-determined number;
transmitting the contact number and the at least one message to a server through at least one data channel;
storing the at least one message at the server;
the server contacting the second communications device; and
either the second communications device drawing the at least one message from the server through at least one data channel, or the server transmitting the at least one message to the second communications device,
wherein the messager sends the at least one message in a manner similar to “compose-and-send” messaging.

38. The method of claim 37, wherein the at least one data channel is selected from the group comprising: WAP, GPRS, 3G, WiMax, 4G, and Wi-Fi.

39. The method of claim 37, wherein both the first communications device and the second communications device are either identical or different.

40. The method of claim 37, wherein the contact number being input is stored in the contact list if the contact number is not in the contact list.

41. The method of claim 37, wherein the contact list is accessible either locally or remotely.

42. The method of claim 37, wherein the server is controlled by a messaging service provider, the first communications device providing the messager's particulars to register the messager with the messaging service provider if the messager is not a registered user of the messaging service provider.

43. The method of claim 42, wherein the registered user of the texting service provider is able to manage a number of credits recognized by the messaging service provider by performing the steps including:
sending the messaging service provider details of the registered user and a credit top-up amount; and
receiving confirmation of receipt which includes transaction reference details and new credit amount from the messaging service provider; wherein the confirmation of receipt is sent to the registered user as at least one message.

44. The method of claim 37, further including the messager installing a messaging application on the first communications device.

45. The method of claim 37, wherein the at least one message is selected from a group comprising: text messages, image-based messages, audio messages, and video messages.

46. The method of claim 37, wherein the server contacts the second communications device using existing phone infrastructure, and the second communications device terminates the call from the server once the server's phone number is detected without intervention from the recipient, with the contact from the server indicating a presence of at least one message which needs to be retrieved from the server.

47. A computer readable medium having a computer program code embodied in the medium, wherein the program code is configured to cause a processor in a communications device to execute a series of processes to carry out the method of claim 37.

48. A system for sending at least one message from a first communications device at any location to a recipient with a second communications device, the system enabling a messager to:
input a contact number of the recipient into the first communications device when sending the at least one message, the contact number being input by selecting from a group comprising: the contact number from a contact list accessible with the first communications device, by manual input of the contact number, and a pre-determined number;
transmit the contact number and the at least one message to a server through at least one data channel;
store the at least one message at the server;
the server connecting with the second communications device; and
either the second communications device drawing the at least one message from the server through at least one data channel, or the server transmitting the at least one message to the second communications device,
wherein the messager sends the at least one message in a manner similar to “compose-and-send” messaging.

49. The system of claim 48, wherein the at least one data channel is selected from the group comprising: WAP, GPRS, 3G, WiMax, 4G, and Wi-Fi.

50. The system of claim 48, wherein both the first communications device and the second communications device are either identical or different.

51. The system of claim 48, wherein the contact number being input is stored in the contact list if the contact number is not in the contact list.

52. The system of claim 48, wherein the contact list is accessible either locally or remotely.

53. The system of claim 48, wherein the server is controlled by a messaging service provider, the first communications device providing the messager's particulars to register the messager with the messaging service provider if the messager is not a registered user of the messaging service provider.

54. The system of claim 53, wherein the registered user of the messaging service provider is able to manage a number of credits recognized by the messaging service provider by performing the steps including:
sending the messaging service provider details of the registered user and a credit top-up amount; and
receiving confirmation of receipt which includes transaction reference details and new credit amount from the messaging service provider; wherein the confirmation of receipt is sent to the registered user as at least one message.

55. The system of claim 48, further including the messager installing a messaging application on the first communications device.

56. The system of claim 48, wherein the at least one message is selected from a group comprising: text messages, image-based messages, audio messages, and video messages.

57. The system of claim 48, wherein the server contacts the second communications device using existing phone infrastructure, and the second communications device terminates the call from the server once the server's phone number is detected without intervention from the recipient, with the contact from the server indicating a presence of at least one message which needs to be retrieved from the server.
